(19) United States
(12) Patent Application Publication
(10) Pub. No.: US 2012/0285645 A1
(43) Pub. Date: Nov. 15, 2012

(54) WATER- AND OIL-RESISTANT AGENT HAVING A DECREASED CONTENT OF VINYL PYRROLIDONE MONOMER

(75) Inventors: Kayo KUSUMI, Settsu-shi (JP); Eiji MASUDA, Settsu-shi (JP)

(73) Assignee: DAIKIN INDUSTRIES, LTD., Osaka (JP)

(21) Appl. No.: 13/432,801

(22) Filed: Mar. 28, 2012

Related U.S. Application Data
(60) Provisional application No. 61/468,828, filed on Mar. 29, 2011.

(51) Int. Cl. C08F 220/22; C08K 3/30; C09D 133/14; D21H 21/00; C08L 33/14; C08K 3/16; C08K 5/07

(52) U.S. Cl. 162/164.7; 526/245; 524/438; 524/423; 524/364

(57) ABSTRACT

A water- and oil-resistant agent obtained by mixing a fluorine-containing copolymer obtained by copolymerizing (a) a (meth)acrylate monomer (a) having a polyfluoroalkyl group having 1 to 6 carbon atoms, (b) a vinylpyrrolidone monomer, (c) a monomer having an anion-donating group, and (d) a fluorine-free (meth)acrylate monomer with a liquid medium and an acid under heating, can have a decreased residual amount of unreacted vinylpyrrolidone monomer of at most 10 ppm and can afford a superior water- and oil-resistance to a paper. The invention also discloses a method of producing the water- and oil-resistant agent, a paper treatment composition comprising the water- and oil-resistant agent, a method for treating a paper with the treatment composition, and a paper treated with the water- and oil-resistant agent.

### CROSS REFERENCE TO RELATED APPLICATIONS

This application claims benefit under 35 U.S.C. §119(e) of U.S. Provisional Application No. 61/468,828 filed Mar. 29, 2011, incorporated herein by reference in its entirety.

### TECHNICAL FIELD

The present invention is related to a water- and oil-resistant agent, comprising a fluorine-containing copolymer and having a decreased residual content of vinyl pyrrolidone monomer, a method of producing said water- and oil-resistant agent, a method of treating paper with said water- and oil-resistant agent, and the treated paper obtained by said method.

### BACKGROUND ART

The copolymer composition comprising a long chain C₆ to C₁₂ polyfluoroalkyl group (hereinafter referred to as “Rf group”) has been utilized previously as the water- and oil-resistant agent for paper, woven fabric, non-woven fabric, etc.

On the other hand, US EPA (United State Environment Protection Agency) pointed out that the long chain Rf group produces perfluoro-octanoic acid (hereinafter referred to as “PFOA”) which might cause an influence on the environment.

Therefore, many efforts have been made to develop a water- and oil-resistant agent for paper by using a fluorine-containing copolymer having a short chain Rf group. The water resistance and the oil resistance, however, tend to decrease along with the decrease of the carbon number of the Rf group, and the water- and oil-resistance is not satisfactory. So, further improvements have to be made to provide a paper having an enough water- and oil-resistance.

WO2003/106519, for example, proposes a water- and oil-resistant agent for paper comprising a fluorine-containing copolymer which contains, as essential components, a fluorine-containing (meth)acrylate monomer having preferably a C₄ to C₁₆ Rf group, a cationic nitrogen-containing monomer such as dimethylaminoethyl methacrylate, N-vinylpyrrolidone (NVP) and an anionic monomer such as acrylic acid. This paper treatment agent has a low viscosity and keeps a high performance even co-used with a cationic paper-strengthening agent. This approach, however, never refers to a residual amount of N-vinyl-2-pyrrolidone and this approach has insufficient oil resistance for a long time.

WO98/23657 proposes a water- and oil-resistant agent for paper comprising a fluorine-containing copolymer having, as essential components, a fluorine-containing (meth)acrylate monomer preferably having a C₄ to C₁₆ Rf group, a cationic nitrogen-containing monomer such as dimethylaminoethyl methacrylate, and a vinyl derivative such as vinyl acetate, wherein the water- and oil-resistant agent is effected by hydrogen peroxide to improve a barrier effect toward oils and fats. Although this water- and oil-resistant agent has fairly improved the water- and oil-resistance, the oil resistance for long time is not sufficient and the amount of residual monomer is not referred to.

As to the decrease of the residual amount of vinyl pyrrolidone monomer in a vinyl pyrrolidone polymer, for example, JP 2006-169507A proposes a method of decreasing a residual N-vinyl-2-pyrrolidone amount in a polymer comprising N-vinyl-2-pyrrolidone by distillation in an acidic condition of pH 2-6. This method is an effective means, but it is not enough to decrease the residual amount of N-vinyl-2-pyrrolidone to a very small amount.

### DISCLOSURE OF INVENTION

### Problems to be Solved by the Invention

An object of the present invention is to provide a water- and oil-resistant agent wherein a residual (or remaining) amount of the vinylpyrrolidone monomer has been decreased (or reduced).

### Means for Solving the Problems

The present inventors discovered that a treatment agent comprising, as an essential component, a fluorine-containing copolymer comprising specified repeat units and having a short chain Rf, which agent is prepared by treatment with addition of an acid, can exhibit a superior water- and oil-resistance. Thus, the present invention has been completed.

That is, the invention is to provide a water- and oil-resistant agent comprising a fluorine-containing copolymer comprising the repeating units derived from:

(a) a fluorine-containing monomer having a fluoroalkyl group represented by the general formula:

CH₂═C(—X)—C(═O)—Y—Z—Rf (1)

wherein X represents a hydrogen atom, a linear or branched C₁ to C₂₁ alkyl group, a fluorine atom, a chlorine atom, a bromine atom, an iodine atom, a CFX¹X² group wherein X¹ and X² are a hydrogen atom, a fluorine atom, a chlorine atom, a bromine atom or an iodine atom, a cyano group, a linear or branched C₁ to C₂₁ fluoroalkyl group, a substituted or non-substituted benzyl group, or a substituted or non-substituted phenyl group;

### Y is —O— or —NH—;

Z is a C₁ to C₁₀ aliphatic group, a C₆ to C₁₀ aromatic or cyclic aliphatic group,
a —CH₂CH₂N(R¹)SO₂— group wherein R¹ is a C₁ to C₄ alkyl group,
a —CH₂CH(OZ¹)CH₂— group wherein Z¹ is a hydrogen atom or an acetyl group,
a —(CH₂)ₘ—SO₂—(CH₂)ₙ— group or a —(CH₂)ₘ—S—(CH₂)ₙ— group wherein m is from 1 to 10 and n is from 0 to 10, and
Rf is a linear or branched C₁ to C₆ fluoroalkyl group,
(b) a vinylpyrrolidone monomer represented by the general formula:

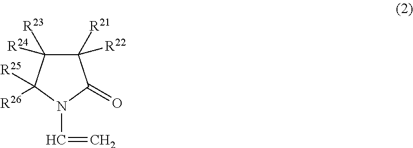

wherein R²¹, R²², R²³, R²⁴, R²⁵ and R²⁶ are the same or different, and represent a hydrogen atom or a C₁ to C₄ alkyl group;
(c) a monomer having an anion-donating group, and
(d) a fluorine free (meth)acrylate monomer,

wherein a residual amount of the vinylpyrrolidone monomer (b) is 10 ppm by weight or less based on the fluorine-containing polymer.

Furthermore, the present invention provides a method of producing a water- and oil-resistant agent, comprising the step of adding an acid to a dispersion or solution of the fluorine-containing copolymer, and heating the dispersion or solution to decrease a residual amount of the vinyl pyrrolidone monomer (b) to 10 ppm by weight or less based on the fluorine-containing copolymer.

The present invention also provides a method of preparing the water- and oil-resistant agent, a method for treating paper with the water- and oil-resistant agent, and a water- and oil-resistant paper obtained by said treatment method.

The water- and oil-resistant agent generally comprises the fluorine-containing copolymer and a liquid medium.

### Effect of the Invention

The present invention provides a water- and oil-resistant agent having a decreased residual amount of a vinyl pyrrolidone monomer. The water- and oil-resistant agent affords superior water- and oil-resistance to the paper.

### EMBODIMENTS FOR CARRYING OUT THE INVENTION

In the present invention, ingredients of the fluorine-containing copolymer have a great influence on the water- and oil-resistance of the water- and oil-resistant agent. The fluorine-containing copolymer used in the present invention is explained as follows.

The fluorine-containing monomer (a) may be substituted by a halogen atom, etc. at the α-position. Therefore, X in the formula (1) may be a hydrogen atom, a linear or branched C₁ to C₂₁ alkyl group, a fluorine atom, a chlorine atom, a bromine atom, an iodine atom, a CFX¹X² group wherein X¹ and X² are a hydrogen atom, a fluorine atom, a chlorine atom, a bromine atom or an iodine atom, a cyano group, a linear or branched C₁ to C₂₁ fluoroalkyl group, a substituted or non-substituted benzyl group, or a substituted or non-substituted phenyl group.

In the formula (1), the Rf group is preferably a perfluoroalkyl group. The carbon number of the Rf group may be 1 to 6, preferably 2 to 6, particularly 4 to 6, typically 6. The examples of the Rf group are —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF(CF₃)₂, —CF₂C(CF₃)₃, —CF(CF₃)CF₂CF₂CF₃, —(CF₂)₅ CF₃ and —(CF₂)₃CF(CF₃)₂. Particularly, —(CF₂)₅ CF₃ is preferable.

Non-limiting examples of the fluorine-containing monomer (a) are exemplified as follows:
CH₂═C(—H)—C(═O)—O—(CH₂)₂—Rf
CH₂═C(—H)—C(═O)—O—C₆H₄—Rf
CH₂═C(—H)—C(═O)—O—(CH₂)₂N(—CH₃)SO₂—Rf
CH₂═C(—H)—C(═O)—O—(CH₂)₂N(—C₂H₅)SO₂—Rf
CH₂═C(—H)—C(═O)—O—CH₂CH(—OH)CH₂—Rf
CH₂═C(—H)—C(═O)—O—CH₂CH(—OCOCH₃)CH₂—Rf
CH₂═C(—H)—C(═O)—O—(CH₂)₂—S—Rf
CH₂═C(—H)—C(═O)—O—(CH₂)₂—S—(CH₂)₂—Rf
CH₂═C(—H)—C(═O)—O—(CH₂)₃—SO₂—Rf
CH₂═C(—H)—C(═O)—O—(CH₂)₂—SO₂—(CH₂)₂—Rf
CH₂═C(—H)—C(═O)—NH—(CH₂)₂—Rf
CH₂═C(—CH₃)—C(═O)—O—(CH₂)₂—Rf
CH₂═C(—CH₃)—C(═O)—O—C₆H₄—Rf
CH₂═C(—CH₃)—C(═O)—O—(CH₂)₂N(—CH₃)SO₂—Rf
CH₂═C(—CH₃)—C(═O)—O—(CH₂)₂N(—C₂H₅)SO₂—Rf
CH₂═C(—CH₃)—C(═O)—O—CH₂CH(—OH)CH₂—Rf
CH₂═C(—CH₃)—C(═O)—O—CH₂CH(—OCOCH₃)CH₂—Rf
CH₂═C(—CH₃)—C(═O)—O—(CH₂)₂—S—Rf
CH₂═C(—CH₃)—C(═O)—O—(CH₂)₂—S—(CH₂)₂—Rf
CH₂═C(—CH₃)—C(═O)—O—(CH₂)₃—SO₂—Rf
CH₂═C(—CH₃)—C(═O)—O—(CH₂)₂—SO₂—(CH₂)₂—Rf
CH₂═C(—CH₃)—C(═O)—NH—(CH₂)₂—Rf
CH₂═C(—F)—C(═O)—O—(CH₂)₂—Rf
CH₂═C(—F)—C(═O)—O—(CH₂)₂—S—Rf
CH₂═C(—F)—C(═O)—O—(CH₂)₂—S—(CH₂)₂—Rf
CH₂═C(—F)—C(═O)—O—(CH₂)₂—SO₂—Rf
CH₂═C(—F)—C(═O)—O—(CH₂)₂—SO₂—(CH₂)₂—Rf
CH₂═C(—F)—C(═O)—NH—(CH₂)₂—Rf
CH₂═C(—Cl)—C(═O)—O—(CH₂)₂—Rf
CH₂═C(—Cl)—C(═O)—O—(CH₂)₂—S—Rf
CH₂═C(—Cl)—C(═O)—O—(CH₂)₂—S—(CH₂)₂—Rf
CH₂═C(—Cl)—C(═O)—O—(CH₂)₂—SO₂—Rf
CH₂═C(—Cl)—C(═O)—O—(CH₂)₂—SO₂—(CH₂)₂—Rf
CH₂═C(—Cl)—C(═O)—NH—(CH₂)₂—Rf
CH₂═C(—CF₃)—C(═O)—O—(CH₂)₂—Rf
CH₂═C(—CF₃)—C(═O)—O—(CH₂)₂—S—Rf
CH₂═C(—CF₃)—C(═O)—O—(CH₂)₂—S—(CH₂)₂—Rf
CH₂═C(—CF₃)—C(═O)—O—(CH₂)₂—SO₂—Rf
CH₂═C(—CF₃)—C(═O)—O—(CH₂)₂—SO₂—(CH₂)₂—Rf
CH₂═C(—CF₃)—C(═O)—NH—(CH₂)₂—Rf
CF₂═C(CF₂H)—C(═O)—O—(CH₂)₂—Rf
CH₂═C(—CF₂H)—C(═O)—O—(CH₂)₂—S—Rf
CH₂═C(—CF₂H)—C(═O)—O—(CH₂)₂—S—(CH₂)₂—Rf
CH₂═C(—CF₂H)—C(═O)—O—(CH₂)₂—SO₂—Rf
CH₂═C(—CF₂H)—C(═O)—O—(CH₂)₂—SO₂—(CH₂)₂—Rf
CH₂═C(—CF₂H)—C(═O)—NH—(CH₂)₂—Rf
CH₂═C(—CN)—C(═O)—O—(CH₂)₂—Rf
CH₂═C(—CN)—C(═O)—O—(CH₂)₂—S—Rf
CH₂═C(—CN)—C(═O)—O—(CH₂)₂—S—(CH₂)₂—Rf
CH₂═C(—CN)—C(═O)—O—(CH₂)₂—SO₂—Rf
CH₂═C(—CN)—C(═O)—O—(CH₂)₂—SO₂—(CH₂)₂—Rf
CH₂═C(—CN)—C(═O)—NH—(CH₂)₂—Rf
CH₂═C(—CF₂CF₃)—C(═O)—O—(CH₂)₂—Rf
CH₂═C(—CF₂CF₃)—C(═O)—O—(CH₂)₂—S—Rf
CH₂═C(—CF₂CF₃)—C(═O)—O—(CH₂)₂—S—(CH₂)₂—Rf
CH₂═C(—CF₂CF₃)—C(═O)—O—(CH₂)₂—SO₂—Rf
CH₂═C(—CF₂CF₃)—C(═O)—O—(CH₂)₂—SO₂—(CH₂)₂—Rf
CH₂═C(—CF₂CF₃)—C(═O)—NH—(CH₂)₂—Rf
CH₂═C(—F)—C(═O)—O—(CH₂)₃—Rf
CH₂═C(—F)—C(═O)—O—(CH₂)₃—S—Rf
CH₂═C(—F)—C(═O)—O—(CH₂)₃—S—(CH₂)₂—Rf
CH₂═C(—F)—C(═O)—O—(CH₂)₃—SO₂—Rf
CH₂═C(—F)—C(═O)—O—(CH₂)₃—SO₂—(CH₂)₂—Rf
CH₂═C(—F)—C(═O)—NH—(CH₂)₃—Rf
CH₂═C(—Cl)—C(═O)—O—(CH₂)₃—Rf
CH₂═C(—Cl)—C(═O)—O—(CH₂)₃—S—Rf
CH₂═C(—Cl)—C(═O)—O—(CH₂)₃—S—(CH₂)₂—Rf
CH₂═C(—Cl)—C(═O)—O—(CH₂)₃—SO₂—Rf
CH₂═C(—Cl)—C(═O)—O—(CH₂)₃—SO₂—(CH₂)₂—Rf
CH₂═C(—CF₃)—C(═O)—O—(CH₂)₃—Rf
CH₂═C(—CF₃)—C(═O)—O—(CH₂)₃—S—Rf
CH₂═C(—CF₃)—C(═O)—O—(CH₂)₃—S—(CH₂)₂—Rf
CH₂═C(—CF₃)—C(═O)—O—(CH₂)₃—SO₂—Rf
CH₂═C(—CF₃)—C(═O)—O—(CH₂)₃—SO₂—(CH₂)₂—Rf
CH₂═C(—CF₂H)—C(═O)—O—(CH₂)₃—Rf
CH₂═C(—CF₂H)—C(═O)—O—(CH₂)₃—S—Rf
CH₂═C(—CF₂H)—C(═O)—O—(CH₂)₃—S—(CH₂)₂—Rf
CH₂═C(—CF₂H)—C(═O)—O—(CH₂)₃—SO₂—Rf
CH₂═C(—CF₂H)—C(═O)—O—(CH₂)₃—SO₂—(CH₂)₂—Rf
CH₂═C(—CN)—C(═O)—O—(CH₂)₃—Rf
CH₂═C(—CN)—C(═O)—O—(CH₂)₃—S—Rf
CH₂═C(—CN)—C(═O)—O—(CH₂)₃—S—(CH₂)₂—Rf
CH₂═C(—CN)—C(═O)—O—(CH₂)₃—SO₂—Rf
CH₂═C(—CN)—C(═O)—O—(CH₂)₃—SO₂—(CH₂)₂—Rf
CH₂═C(—CF₂CF₃)—C(═O)—O—(CH₂)₃—Rf
CH₂═C(—CF₂CF₃)—C(═O)—O—(CH₂)₃—S—Rf
CH₂═C(—CF₂CF₃)—C(═O)—O—(CH₂)₃—S—(CH₂)₂—Rf
CH₂═C(—CF₂CF₃)—C(═O)—O—(CH₂)₃—SO₂—Rf
CH₂═C(—CF₂CF₃)—C(═O)—O—(CH₂)₂—SO₂—(CH₂)₂—Rf
   wherein Rf is a fluoroalkyl group of C₁ to C₆, preferably C₄ to C₆.

The fluoroalkyl group (Rf) in the fluorine-containing monomer (a) may be, preferably a perfluoroalkyl group, and most preferably a C₄ to C₆ perfluoroalkyl group.

The fluorine-containing monomer (a) may be a mixture of two or more monomers.

The vinylpyrrolidone monomer (b) represented by the general formula (2) is N-vinyl-2-pyrrolidone or a N-vinyl-2-pyrrolidone derivative which may have C₁ to C₄ alkyl substituent, for example, a methyl group, on a ring. Examples of the monomer (b) include at least one selected from the group consisting of N-vinyl-2-pyrrolidone, N-vinyl-3-methyl-2-pyrrolidone, N-vinyl-4-methyl-2-pyrrolidone, N-vinyl-5-methyl-2-pyrrolidone and N-vinyl-3,3-dimethyl-2-pyrrolidone.

The monomer (c) is a compound having an anion-donating group and a carbon-carbon double bond. The anion-donating group may be a carboxyl group or a sulfonic acid group. The monomer (c) may have 2 to 15 carbon atoms. The monomer (c) may be preferably at least one selected from the group consisting of (meth)acrylic acid, crotonic acid, maleic acid, phthalic acid, fumaric acid, itaconic cid, citraconic acid, vinyl sulfonic acid, (meth)allyl sulfonic acid, styrene sulfonic acid, vinylbenzene sulfonic acid, acrylamide-tert-butyl sulfonic acid, and salts thereof. The particularly preferable monomer (c) is methacrylic acid or acrylic acid.

The fluorine-free (meth)acrylate monomer (d) may be a (meth)acrylate monomer free from a fluorine atom, represented by the general formulas:

CH₂═CX¹C(═O)—O—(RO)ₙ—X² (3a)

and/or

CH₂═CX¹C(═O)—O—(RO)ₙ—C(═O)CX¹═CH₂ (3b)

wherein X¹ is a hydrogen atom or a methyl group,
X² is a hydrogen atom or a saturated or unsaturated C₁ to C₂₂ hydrocarbon group,
R is a C₂ to C₆ alkylene group, and
n is an integer from 1 to 90.

Another example of fluorine-free monomer (d) may be a (meth)acrylate ester having an alkyl group. The number of carbon atoms of the alkyl group may be from 1 to 30. For example, the (meth)acrylate ester monomer may be (meth)acrylate of the general formula:

CH₂═CA¹COOA² (3c)

wherein A¹ is a hydrogen atom or a methyl group, and A² is an alkyl group represented by CₙH₂ₙ₊₁ (n=1 to 30). The examples thereof may be one or a mixture of methyl(meth)acrylate, n-butyl(meth)acrylate, t-butyl(meth)acrylate, 2-ethylhexyl(meth)acrylate, lauryl(meth)acrylate, stearyl(meth)acrylate and behenyl(meth)acrylate.

Further other examples of the fluorine-free (meth)acrylate monomer (d) may be a (di)(meth)acrylate monomer having a hydroxyalkyl group. The number of carbon atoms in the hydroxyalkyl group may be from 1 to 30. Specific example of the (di)(meth)acrylate monomer includes pentaerythritol tri(meth)acrylate and trimethylpropane di(meth)acrylate.

Preferably, the fluorine-free (meth)acrylate monomer (d) may be oxyalkylene(meth)acrylate of the general formula (3a) wherein X² is a hydrogen atom, R is a saturated hydrocarbon group having 2 carbon atoms, and average of n is 10 or less, and may be particularly preferably one or a mixture of 2-hydroxyethyl(meth)acrylate and ω-hydroxy-polyoxyethylene acrylate (Average polymerization degree (n) of the polyoxyethylene group: n=3-30). Examples of ω-hydroxy-polyoxyethylene acrylate include BLEMMER® AE-200 (n=4.5) produced by NOF Corporation.

The fluorine-free (meth)acrylate monomer (d) may be one or a mixture of at least two of the monomers exemplified in the above.

The weight ratio among the monomers (a), (b), (c) and (d) in the fluorine-containing copolymer may be (a):(b):(c):(d)=40-90:1-30:1-30:1-40 by weight based on the weight (100%) of total of monomers constituting the fluorine-containing copolymer.

Preferably, the weight ratio of (a):(b):(c):(d) may be 45-85:1-20:1-20:1-30% by weight. More preferably, the weight ratio of (a):(b):(c):(d) may be 60-85:1-15:1-15:1-25% by weight.

The water- and oil-resistant agent of the present invention may be a composition comprising the fluorine-containing copolymer. The composition comprising the fluorine-containing copolymer may be a liquid which is a mixture with the liquid medium (that is, a liquid of the fluorine-containing copolymer). The composition may be a dispersion of the fluorine-containing copolymer or a solution of the fluorine-containing copolymer, particularly a solution of the fluorine-containing copolymer.

The present invention provides a method comprising the step of decreasing the content of a vinyl pyrrolidone monomer as an unreacted monomer remaining in the dispersion or solution of the fluorine-containing copolymer by using acid. Preferably, the vinyl pyrrolidone monomer decrease step is performed after the step of polymerizing the monomer and before the step of neutralizing the anionic donating group (e.g., carboxyl group or sulfonate group) of the fluorine-containing copolymer. In the decrease step, the acid is added to the liquid (i.e., the dispersion or solution of the fluorine-containing copolymer) which contains the fluorine-containing copolymer, the liquid medium and the unreacted monomer. The acid to be used may be an acid having a low molecular weight (e.g., molecular weight of 20 to 500, particularly 30 to 200) and may be any of an organic acid (particularly carboxylic acid) or an inorganic acid. Specific examples of the acid include organic acids such as formic acid, acetic acid, propionic acid, phthalic acid, malonic acid, aspartic acid, succinic acid, citric acid, glutamic acid, malic acid, trimellitic acid, pyromellitic acid and lactic acid; and inorganic acids such as phosphoric acid, hydrochloric acid, nitric acid, sulfuric acid and carbonic acid. Organic acids and the inorganic acids are not limited to those mentioned above. Of these, one or combinations of at least two may be used.

A pH (measured at 25° C.) value of the liquid is adjusted to 3 or less, preferably 2.5 or less, more preferably 2.2 or less, particularly 2.0 or less by adding the acid to the dispersion or solution of the fluorine-containing copolymer. Generally, the lower limit of pH is 1.0. By the pH reduction, the content of the vinyl pyrrolidone monomer can be reduced.

In the decrease step, the dispersion or solution of the fluorine-containing copolymer is heated to at least 80° C. under stirring. That is, the dispersion or solution is mixed at a temperature of 80° C. or more, e.g., 85° C. or more, preferably 90° C. or more, after the acid is added to the dispersion or solution of the fluorine-containing copolymer. Generally, the upper limit of the heating temperature is 130° C. When the temperature is 80° C. or more, the vinyl pyrrolidone monomer can be reduced to 10 ppm by weight or less based on the fluorine-containing copolymer, in a short time. Generally, the heating time may be from 10 minutes to 500 minutes, e.g., from 20 minutes to 300 minutes, preferably from 30 minutes to 240 minutes. When the heating time is from 10 minutes to 500 minutes, the remaining vinyl pyrrolidone monomer amount can be reduced more with a longer heating time without spoiling the stability of the product.

The liquid medium contained in the dispersion or solution of the fluorine-containing copolymer may be water alone or an organic solvent alone, but the liquid medium is preferably a mixed solvent of water and the organic solvent. In the mixed solvent, the organic solvent may be one or a mixture of at least two. Preferably, the organic solvent is water-soluble or water-dispersible organic solvent. Non-limiting examples of the organic solvents include ketones (e.g., acetone or methyl ethyl ketone), alcohols (e.g., methanol, ethanol and isopropanol), ethers (e.g., methyl or ethyl ether of ethylene glycol or propylene glycol and ester acetate thereof, tetrahydrofuran and dioxane), acetonitrile, dimethylformamide, N-methyl-2-pyrrolidone, butyrolactone and dimethyl sulfoxide. The liquid medium is used as a solvent working as a polymerization solvent at the time of polymerization. The liquid medium (solvent) additionally added after the polymerization step may be the same as or different from the liquid medium used as the polymerization solvent.

The preferred examples of the mixed solvent may be a mixture selected from a mixture of water and ketones (one or both of acetone and methyl ethyl ketone), a mixture of water and alcohols (one or at least two of methanol, ethanol and isopropanol), a mixture of water and ethers (one or both of methyl and methyl or ethyl ethers of ethylene glycol), or a mixture of water and at least two selected from ketones, alcohols and ethers. More preferable examples of the solvent include water; water and acetone; water and methyl ethyl ketone; water and methanol; and water and isopropyl alcohol. In the mixed solvent of water and the organic solvent, the mixing weight ratio of water to the organic solvent is 10-90:10-90, for example, 15-70:30-85, more preferably 20-70:30-80, particularly 25-67:33-75.

The addition amount (content) of the acid used to give an objective pH value may be 30-1500 ppm by weight, preferably 50-1000 ppm by weight, more preferably 100-1000 ppm by weight, based on a fluorine-containing copolymer. The acid amount of 30-1500 ppm by weight can reduce the amount of the vinyl pyrrolidone monomer in a short time, without corroding a metallic reaction vessel used for polymerization, and without aggregating and precipitating the polymer.

Preferably, the concentration of the fluorine-containing copolymer in dispersion or solution of the fluorine-containing copolymer is 10-60% by weight, e.g., 20-50% by weight. The concentration of 10-60% by weight can complete the vinyl pyrrolidone decrease step in a short time, without the aggregation of the copolymer. The weight ratio of the fluorine-containing copolymer to the liquid medium may be (fluorine-containing copolymer:liquid medium=) 15-70:30-85.

Preferably, the addition amount of the acid for reducing the vinyl pyrrolidone monomer amount is less. More preferably, the inorganic acid such as phosphoric acid, hydrochloric acid, nitric acid and sulfuric acid is used. Among these, the particularly preferred acid is hydrochloric acid and sulfuric acid. When, for example, sodium hydroxide is used for neutralization, it is neutralized with these acids to produce sodium chloride and sodium sulfate, and there is the advantage that a method of using the acids is hardly limited even if in the case of, for example, a food application. The reduced amount of the vinyl pyrrolidone monomer may be 10 ppm by weight or less, preferably 5 ppm by weight or less, more preferably 3 ppm by weight or less, particularly 2 ppm by weight or less, based on the fluorine-containing copolymer. If there is a large residual amount of the vinyl pyrrolidone monomer, a bad smell may undesirably remain in a product. The residual amount of the vinyl pyrrolidone monomer can be measured by detecting absorption strength in 235 nm using a UV detector after having separated by high performance liquid chromatography (HPLC).

Preferably, after the decrease step, the step of neutralizing the anionic donating group of the fluorine-containing copolymer is performed.

Therefore, the method of producing the water- and oil-resistant agent according to the present invention preferably comprises the steps of:

(1) polymerizing a monomer in the presence of a liquid medium, optionally adding an additional liquid medium after the polymerization, to give a dispersion or solution of a fluorine-containing copolymer,
(2) adding an acid to the dispersion or solution of a fluorine-containing copolymer, and heating the dispersion or solution to decrease the residual amount of the vinyl pyrrolidone monomer (b) to 10 ppm by weight or less based on the fluorine-containing copolymer, and
(3) neutralizing an anionic donating group of the fluorine-containing copolymer.

The additional liquid medium added after polymerization may be the same as or different from the liquid medium existing at the time of polymerization.

In the present invention, there is no limitation on the molecular weight of the fluorine-containing copolymer. Considering the water- and oil-resistance properties and the viscosity of the paper treatment agent, the weight-average molecular weight (in terms of polystyrene) measured by gel permeation chromatography (GPC) is generally 3,000 or more, and preferably, in the range of 5,000 to 1,000,000.

The preferable embodiments of the fluorine-containing copolymer in the present invention are shown as follows.

As one example of the preferable embodiments of the ingredients of the fluorine-containing copolymer, the monomer (a) represented by the general formula (1) is at least one fluorine-containing monomer wherein Rf represents a C₄ to C₆ perfluoroalkyl group, the monomer (b) is at least one selected from the group consisting of N-vinyl-2-pyrrolidone, N-vinyl-3-methyl-2-pyrrolidone, N-vinyl-4-methyl-2-pyrrolidone, N-vinyl-5-methyl-2-pyrrolidone and N-vinyl-3,3-dimethyl-2-pyrrolidone, the monomer (c) is at least one selected from the group consisting of (meth)acrylic acid, crotonic acid, maleic acid, phthalic acid, fumaric acid, itaconic acid and citraconic acid, and the monomer (d) is at least one selected from the group consisting of oxyalkylene(meth)acrylates represented by the general formula (3a) wherein n is 10 or less, X² is a hydrogen atom, and R is a saturated C₂ hydrocarbon group.

Specifically is exemplified the embodiment wherein the fluorine-containing monomer (a) is F(CF₂)₄CH₂CH₂OCOCH═CH₂ or F(CF₂)₆CH₂CH₂OCOCH═CH₂ or a mixture thereof, the monomer (b) is N-vinyl-2-pyrrolidone, the monomer (c) is methacrylic acid or acrylic acid, and the monomer (d) is 2-hydroxyethyl methacrylate or ω-hydroxy-polyoxyethylene acrylate (wherein an average polymerization degree (n) of the polyoxyethylene group is 3 to 10) or a mixture thereof. Further specifically is exemplified the embodiment wherein the monomer (a) is F(CF₂)₄CH₂CH₂OCOCH═CH₂ or F(CF₂)₆CH₂CH₂OCOCH═CH₂ or a mixture thereof, the monomer (b) is N-vinyl-2-pyrrolidone, the monomer (c) is acrylic acid and the monomer (d) is 2-hydroxyethyl(meth)acrylate or ω-hydroxy-polyoxyethylene acrylate (wherein an average polymerization degree (n) of the polyoxyethylene group is 3 to 10) or a mixture thereof, and the weight ratio of (a):(b):(c):(d) is 60-85:1-15:1-15:1-25.

An example of preferred embodiments of the decrease of the remaining vinyl pyrrolidone monomer in the dispersion or solution of the fluorine-containing copolymer according to the present invention is that the weight ratio of the fluorine-containing copolymer to liquid medium is 28.5-40:60-71.5 (% by weight), the used acid is hydrochloric acid or sulfuric acid, or a mixture of these, and the amount of the acid is 30 to 1500 ppm by weight, for example, 80 to 1200 ppm by weight, particularly 200 to 1000 ppm by weight, based on the fluorine-containing copolymer.

The fluorine-containing copolymer of the present invention may be any of a “solvent type” homogeneously dissolved in a solvent or a “water-dispersion type” dispersed in water. As to the water-dispersion type, the copolymer may be dispersed in water in a salt form of the polymer prepared by neutralization or may be emulsified in water by using an emulsifier. Since the fluorine-containing copolymer of the present invention contains a monomer having an anion-donating group such as a carboxyl group or sulfonic acid group, it can be neutralized by alkali resulting in the “water-dispersion type” of a salt form. Therefore, the amount of a volatile solvent can be reduced or eliminated to eventually afford a water- and oil-resistant agent. The water- and oil-resistant agent of the present invention is suitable for, particularly a water- and oil-resistant agent for paper.

The present invention provides a method of preparing a water- and oil-resistant agent having a decreased amount of vinyl pyrrolidone monomer.

The present invention also provides a method for water- and oil-resistant-treating paper, wherein the method comprises a step of applying the water- and oil-resistant agent of the present invention to the whole paper including internal parts of the paper. This treatment method is hereinafter referred to as an “internal application process”. In this process, the water- and oil-resistant agent of the present invention comprising a fluorine-containing copolymer is applied to a pulp at a papermaking stage. Specifically, it is preferable to apply the water- and oil-resistant agent in an amount that the ratio of the fluorine atoms is, for example, 0.01 to 1.0% by weight based on the weight of the pulp.

The present invention also relates to a method for treating paper to be water- and oil-resistant, wherein the method comprises a step of applying the water- and oil-resistant agent of the present invention to a surface of the paper. This treatment method is hereinafter referred to as a “surface application process” (or “external application process”. In this process, it is preferable to apply the water- and oil-resistant agent comprising a fluorine-containing copolymer in an amount that the ratio of the fluorine atoms is, for example, 0.005 to 0.6% by weight based on the weight of the paper.

The water- and oil-resistant agent of the present invention can be used in either of the surface application process or the internal application process. The internal application process in which the paper treatment agent is applied to the whole parts of the paper including internal parts is preferable since the internal application process provides a good mixture of the water- and oil-resistant agent with the pulp, and thus the process can suppress the decrease of the water- and oil-resistance by a crease or a corrugation of the paper. On the other hand, the surface application process has a wide applicability, since, in the surface application process, (i) the water- and oil-resistant agent is applied to a nearby area around the surface of the paper and thus effectively improves the water- and oil-resistance around the surface by the fluorine-containing copolymer, (ii) the process does not need much water in the treatment step thus reducing the amount of a waste water, and (iii) the process is simple.

The present invention also provides a paper treatment composition comprising the water- and oil-resistant agent of the present invention. The paper treatment composition may comprise, in addition to the water- and oil-resistant agent, an additive, for example, a sizing agent, a paper strengthening agent, a retention aid, a dyestuff, a fluorescent dyestuff, a filler, a slime-controlling agent, an anti-slipping agent and a deformer.

The present invention also provides a water- and oil-resistant paper treated with the water- and oil-resistant agent of the present invention. The present invention also provides a paper obtained by the internal application process or the surface application process.

The production of the fluorine-containing copolymer of the present invention can be carried out by polymerizing monomers (a), (b), (c) and (d) in a liquid medium. The liquid medium is preferably a water soluble or water dispersible solvent (particularly an organic solvent). The liquid medium may be a mixture comprising water and the water soluble or water dispersible solvent. The monomer and the liquid medium preferably are in a form of a solution wherein the monomer is dissolved or dispersed in the liquid medium. The polymerization may be a solution polymerization or an emulsion polymerization, preferably a solution polymerization in view of stability of polymerization reaction. A polymerization temperature is preferably from 40 to 130° C., particularly from 50 to 90° C.

The step of decreasing the residual amount of the vinyl pyrrolidone monomer in the dispersion or solution of a fluorine-containing copolymer is conducted after the copolymerization.

The step of neutralizing the units derived from the monomer (c) (an anion donating group) with adding an aqueous solution of inorganic or organic base may be conducted after the vinylpyrrolidone monomer decrease step. The temperature of the dispersion or solution of fluorine-containing copolymer may be from 20 to 90° C., particularly from 40 to 80° C.

Examples of the inorganic or organic bases include sodium hydroxide, potassium hydroxide, ammonia, triethylamine, tri-n-propylamine, triisopropylamine, tri-n-butylamine, tri-sec-butylamine, ethanolamine, diethanolamine, triethanolamine, 2-amino-2-methyl-1-propanol, 2-aminomethyl-1,3-propanediol, 2-amino-2-hydroxymethyl-1,3-propanediol, bis(hydroxymethyl)methylaminomethane, tris(hydroxymethyl)aminomethane, lysine, and arginine. Among these bases, sodium hydroxide, potassium hydroxide, ammonia, triethylamine, diethanolamine, triethenolamine, etc. are preferable from the view point of the improvement of the dispersing stability of the obtained fluorine-containing copolymer in water or the aqueous medium.

Among them, sodium hydroxide or ammonia are preferably used. Preferably, the amount of the aqueous solution and the concentration of the base to be used are the amount enough to neutralize a carboxyl group or sulfonate group of monomer (c) and to give a stable aqueous dispersion.

Advantageously, the amount of the base for neutralizing a carboxyl group or sulfonate group is 0.05 to 5 equivalents, preferably 0.1 to 3 equivalents, based on the monomer (c).

The polymer mixture after copolymerization may be, if necessary, diluted by adding the liquid medium (for example, water or an aqueous solution containing inorganic or organic bases).

Non-limiting examples of the water-soluble or water-dispersible organic solvents utilized in copolymerization include ketones (for example, acetone or methyl ethyl ketone), alcohols (for example, methanol, ethanol and isopropanol), ethers (for example, methyl or ethyl ether of ethylene glycol or propylene glycol, acetate ester thereof, tetrahydrofuran and dioxane), acetonitrile, dimethylformamide, N-methyl-2-pyrollidone, butyllactone and dimethylsulfoxide. Among them, acetone, methyl ethyl ketone (MEK), N-methyl-2-pyrollidone (NMP), methanol, ethanol and isopropanol are preferably used as the solvent. The total monomer concentration in the solution may be in the range of 20 to 70% by weight, preferably 40 to 60% by weight.

The copolymerization may be carried out using at least one initiator in the range of 0.1 to 3.0% by weight based on the total weight of the monomers. The following initiators may be used: peroxides such as benzoyl peroxide, lauroyl peroxide, succinyl peroxide and tert-butyl peroxypivalate, or azo-compounds such as 2,2-azobis-isobutylonitrile, 4,4-azobis(4-cyanopentanoic acid) and azodicarbonamide.

A chain transfer agent may be used for controlling the molecular weight of the copolymer. Preferable examples of the chain transfer agent include alkyl mercaptan (such as octyl mercaptan, dodecyl mercaptan, lauryl mercaptan, stearyl mercaptan), aminoethanethiol, mercaptoethanol, thioglycollic acid, methyl thioglycollate and 2-mercaptopropionic acid. The amount of the chain transfer agent used may be in a range of 0.001 to 5, for example, 0.01 to 5 parts by weight, preferably 0.01 to 2 parts by weight based on 100 parts by weight of the total monomers in the copolymerization.

The copolymerization can be carried out generally in the range from 40° C. to the boiling point of the reaction mixture.

The dilution step may be carried out by adding a liquid medium, for example, water or an aqueous solution of a strong or moderate inorganic or organic base into the solution of fluorine-containing copolymer. The above described bases are exemplified as such a base usable for the dilution step.

The final solid content of the fluorine-containing copolymer solution after dilution can take a wide range. For example, a range of 5 to 35% by weight, preferably 10 to 30% by weight can be selected.

The paper, to which the water- and oil-resistant agent (particularly the water- and oil-resistant agent for paper) comprising the fluorine-containing copolymer as an active component according to the present invention is to be applied, can be produced by the conventional paper making method. Both processes may be used: the internal application process wherein the treating agent is added to the pulp slurry before paper making, and the surface application process wherein the treating agent is applied to the paper after paper making.

In case of applying the water- and oil-resistant agent of the present invention to the whole of paper including internal parts of the paper (the internal application process), it is preferable to use the water- and oil-resistant agent in such an amount that the weight ratio of the fluorine atoms is in the range of 0.01 to 1.0% by weight, particularly, 0.02 to 0.6% by weight based on the weight of the pulp. On the other hand, when the water- and oil-resistant agent is applied to the surface of the paper (the surface application process), it is preferable to use the water- and oil-resistant agent in such amount that the weight ratio of the fluorine atoms is in the range of 0.005 to 0.6% by weight, for example, 0.01 to 0.4% by weight based on the weight of the paper.

The paper substrate thus treated exhibits a superior water- and oil-resistance generally after heat treatment at room temperature or at high temperature, or if necessary depending on the nature of the paper substrate, by accompanying a heat treatment which can be at a higher temperature range of 70° C. or more.

Examples of the paper substrate treated with the method of the present invention include a raw paper for plaster board, a coated raw paper, a wood-containing paper, a general liner and a flute, a neutral white role paper, a neutral liner, an anti-corrosion liner, a paper combined with metal and a kraft paper. The following paper substrate are further exemplified: a neutral paper for printing and writing, a neutral coated raw paper, a neutral paper for PPC, a neutral heat-sensitive paper, a neutral pressure-sensitive paper, a neutral paper for ink-jet, and a neutral paper for information industry. Other papers such as a mold paper formed by molding, particularly, a molded paper vessel, are exemplified. A pulp-molded vessel can be produced by the method described in the JP9-183429A.

The following materials can be utilized as a starting pulp materials for paper: a bleached or unbleached chemical pulp such as a kraft pulp or a sulfite pulp, a bleached or unbleached high-yield pulp such as a grand pulp, a mechanical pulp or a thermo-mechanical pulp, and a waste pulp such as a waste paper of newspaper, magazine, cardboard or deinked paper, non-wood pulp such as bagasse pulp, kenaf pulp or bamboo pulp. The mixtures may be also utilized between the pulp materials above mentioned and any one of synthetic fibers such as polyamide, polyimide, polyester, polyolefin and polyvinylalcohol.

When the surface application process and the internal application process are applied, a size agent, in addition to the water- and oil-resistant agent, can be added optionally to improve the water resistance of the paper. The examples of the size agent are a cationic size agent, an anionic size agent and a rosin size agent (for example, an acidic rosin size agent, a neutral rosin size agent). Among them, a styrene-acrylic acid copolymer, alkenyl succinic anhydride and an alkylketene dimer are preferable. The amount of the size agent may be 0.001 to 5% by weight based on the amount of the pulp.

If necessary, other agents generally added to the paper treatment agent may be used: a paper strengthening agent such as starch, various modified starch, caroboxymethyl-cellulose, polyamide-polyamine-epichlorohydrin (PAE), poly-diallyldimethylammonium chloride (poly-DADMAC) and polyacrylamide (PAM) etc., a retention aid, a dyestuff, a fluorescent dyestuff, a filler, a slime-controlling agent, an anti-slipping agent, a deformer, etc.

In the surface application process, the paper treatment agents can be applied to the paper by means of a size press, coating (such as a gate roll coater, a bill blade coater and a bar coater) and a spray apparatus.

### EXAMPLES

The followings are examples which specifically explain the present invention. These examples are for the explanation of the present invention, but do not limit the present invention. The terms “parts”, “%” and “ppm” read, if not specified, “parts by weight”, “% by weight” and “ppm by weight”, respectively.

The testing methods used are as follows:

“Stability test”

The stability of the dispersion of fluorine-containing copolymer in water (an aqueous dispersion) was observed as follows: The aqueous dispersion having a solid content being adjusted to 20% by weight was left standing at 60° C. for 30 days, and the dispersion state was visually observed by eyes whether a sedimentation or a coagulation occurred or not. The evaluation was summarized as follows: “Good” stands for absence of sedimentation or coagulation; “Fair” stands for fractional sedimentation or aggregation; “Poor” stands for large sedimentation or coagulation.

“Water resistance test: Cobb test (JIS P8140)”

The test consists of measuring the weight (g) of the water absorbed in one minute by the paper having 100 cm² area and supporting 1 cm height of water, and converting the measured value in terms of a weight per 1 m² (g/m²).

“Oil resistance test (Kit Test)”

The oil resistance was measured according to the TAPPI T-559 cm-02 method. The test oil shown in Table 1 was placed on the paper, then, after 15 seconds, the infiltration state of the oil was observed. The maximum point of an oil resistance given by the oil having no infiltration was assigned to be an oil resistance of the paper.

TABLE 1
Table 1. Relations between test oil and oil resistance

| Degree of | | | |
|---|---|---|---|
| oil | Caster | | |
| resistance | oil | Toluene | n-Heptane |
| 1 | 100 | 0 | 0 |
| 2 | 90 | 5 | 5 |
| 3 | 80 | 10 | 10 |
| 4 | 70 | 15 | 15 |
| 5 | 60 | 20 | 20 |
| 6 | 50 | 25 | 25 |
| 7 | 40 | 30 | 30 |
| 8 | 30 | 35 | 35 |
| 9 | 20 | 40 | 40 |
| 10 | 10 | 45 | 45 |
| 11 | 0 | 50 | 50 |
| 12 | 0 | 45 | 55 |

### “AGR (Aggressive-grease Resistance) Test”

This test is particularly useful to verify the anti-grease paper suitability for the pet-food packaging. Briefly, this test implies the contact in standardized conditions between the pet-food and the paper specimen to be tested. The pet-food with the trademark Science Diet (produced by Hill's Inc.) was used as the pet-food for testing. The pet-food is finely milled in a mixer. An anti-grease paper specimen, having 10×10 cm sizes, is cut out to be tested, and placed over a coated paper sheet on which a grid of 100 small squares is printed, having a surface exactly equal to that of specimen to be tested. Before fitting the position on the grid, the specimen is slightly creased. First of all, the specimen is folded back along the line connecting the centers of the facing two edges, and the crease is reinforced by a proper roll (weight: 2450+110 g; diameter: 8 cm; width: 7 cm) covered with a hard rubber layer with 0.6 cm thickness and having a controlled hardness. The roll speed is 50-60 cm/sec. during the creasing. The specimen is subjected to a first crease made along a line connecting centers of opposite edges of the specimen, and a second crease is made by creasing the paper along a line connecting centers of other opposite edges of the specimen. The specimen with the creases is transferred on the grid so that the specimen wholly covers the grid surface. A metal ring having a diameter of 7.2 cm and a height of 2.5 cm is placed in the middle of the paper specimen to be tested. Then 36 g of milled pet-food are taken, which are homogeneously paced inside the ring on the paper specimen to be tested. A weight equal to 1.5 kg, cylinder-shaped, is then placed on the milled pet-food applied to the paper specimen. The whole is put in a stove at 60° C. and 50% humidity for 24 hours. This time elapsed, the weight and the pet-food are removed and the specimen surface is tested to find fat stains, which would witness the occurred fat penetration. The test result is expressed in terms of percentage of stained surface. The lower value indicates the lower exuding and better resistance. To have a significant result, the test is carried out on at least 4 specimens subjected to the same treatment and the final result is the average of the 4 tests.

### “RP-2 Test”

This test is mainly utilized to verify the adequacy of the oil resistant paper for the pet-food packaging. An anti-grease paper specimen, having a size of 10 cm×10 cm, is cut out to be tested, and placed over a coated paper sheet, on which a grid of 100 small squares is printed, having a surface exactly equal to that of specimen to be tested. Before fitting the position on the grid, the specimen is slightly creased. First of all, the specimen is folded back along the line connecting the centers of the facing two edges, and the crease is reinforced by a proper roll (weight: 2450±110 g; diameter: 8 cm; width: 7 cm) covered with a hard rubber layer having 0.6 cm thickness and having a controlled hardness. The roll speed is 50-60 cm/sec. during the creasing. The specimen is subjected to a first crease made along a line connecting centers of opposite edges of the specimen, and a second crease is made by creasing the paper along a line connecting centers of other opposite edges of the specimen. The specimen with the creases is transferred on the grid so that the specimen wholly covers the grid surface. A plastic pipe (height: 2.5 cm, internal diameter: 2.5 cm) is placed in the middle of the specimen, then 5 g of sand (Soma standard sand: 500-850 μm) are poured into the pipe. The pipe is then removed so as to form a sand cone in the middle of the specimen. Then 1.3 ml of a specific synthetic oil produced by Ralston Purina which contains a red dye are added to the sand cone to leak into the cone. The specimens with the sand are then kept in a stove at 60° C. and 50% of relative humidity for 24 hours. At the end, the sand mound penetrated with the oil is removed, and the underlying grid surface of the coat paper stained by the colored oil is evaluated. The RP-2 test result is then expressed as number of stained small squares, which expresses also the % of the stained squares of the grid. The lower value indicates the lower exuding and better oil resistance. In order to obtain a result of significance, the final value is the average of the results obtained on at least 4 specimens of the same sample.

### Synthesis Example 1

Hundred (100) parts by weight of methyl ethyl ketone (MEK) as a solvent was introduced into a 300 ml reaction vessel equipped with a stirrer, a thermometer, a refluxing condenser, a dropping funnel, a nitrogen gas inlet and a heater. Then, with stirring, a monomer (total 100 parts) consisting of 77 parts of F(CF₂)₆CH₂CH₂OCOCH═CH₂ (hereinafter referred to as “C6FA”), 10 parts of N-vinyl-2-pyrrolidone (NVP), 8 parts of 2-hydroxyethyl methacrylate (HEMA) and 5 parts of acrylic acid (AA), and an initiator, tert-butyl peroxypivalate (1 part), were added in these sequences to obtain a mixture, which was further stirred for 12 hrs. under the nitrogen atmosphere at 60° C. to complete the copolymerization and cooled to the room temperature, thereby giving 201 parts (100 g) of a solution (S1) of a fluorine-containing copolymer. The concentration of the copolymer in the obtained solution was 50%.

### Synthesis Example 2

The copolymerization was carried out in the same procedure as in Synthesis Example 1 except that 0.03 parts of lauryl mercaptan (L-SH) as a chain transfer agent and 1 part of an initiator, tert-butyl peroxypivalate were added in these sequences to a monomer (total 100 parts) consisting of 72 parts of F(CF₂)₆CH₂CH₂OCOCH═CH₂ (“C6FA”), 8 parts of N-vinyl-2-pyrrolidone (NVP), 15 parts of 2-hydroxyethyl methacrylate (HEMA) and 5 parts of acrylic acid (AA), to give 201 parts (100 g) of a solution (S2) of a fluorine-containing copolymer. The concentration of the copolymer in the obtained solution was 50%.

### Synthesis Example 3

The copolymerization was carried out in the same procedure as in Synthesis Example 1 except that 70 parts of F(CF₂)₆CH₂CH₂OCOCH═CH₂ (“C6FA”), 7 parts of N-vinyl-2-pyrrolidone (NVP), 12 parts of 2-hydroxyethyl methacrylate (HEMA), 8 parts of acrylic acid (AA), 3 parts of ω-hydroxy-polyoxyethylene acrylate (BLEMMER® AE-200 produced by NOF Corporation: the average polymerization degree (n) of the polyoxyethylene group=4.5) and 1 part of an initiator, tert-butyl peroxypivalate were added in these sequences to give 201 parts (100 g) of a solution (S3) of the fluorine-containing copolymer. The concentration of the copolymer in the obtained solution was 50%.

### Preparation Example 1

12.4 g of water and 0.125 g of 10% hydrochloric acid (HCl is 500 ppm by weight based on the fluorine-containing copolymer) were added to the solution (S1: 50 g) of the fluorine-containing copolymer obtained in Synthesis Example 1, mixed at 85° C. for 240 minutes and adjusted to 50° C. 4.9 g of a 10% aqueous NaOH solution as a base and 90 g of ion-exchanged water were added to the mixture and emulsified and then MEK was evaporated off by an evaporator under reduced pressure with heating to give a pale yellow transparent dispersion of the fluorine-containing copolymer (a content of volatile organic solvent is at most 1%). Ion-exchanged water was further added to this aqueous dispersion to give an aqueous dispersion (SD1) having a solid content of 20%. This aqueous dispersion had a residual vinyl pyrrolidone content of 3 ppm by weight based on the fluorine-containing copolymer.

### Preparation Example 2

The same procedure as in Preparative Example 1 was repeated to give an aqueous colorless transparent dispersion (SD2) having a solid content of 20%, except that 24.9 g of water and 0.225 g of 10% hydrochloric acid (HCl is 900 ppm by weight based on the fluorine-containing copolymer) were added to the solution (S2) of the fluorine-containing copolymer obtained in Synthesis Example 2, mixed at 90° C. for 120 minutes and adjusted to 70° C., and 4.9 g of a 10% aqueous NaOH solution as a base and 90 g of ion-exchanged water were added. This aqueous dispersion had a residual vinyl pyrrolidone content of 1 ppm by weight based on the fluorine-containing copolymer.

### Preparation Example 3

The same procedure as in Preparative Example 1 was repeated to give an aqueous colorless transparent dispersion (SD3) having a solid content of 20%, except that 37.4 g of water and 0.025 g of 10% sulfuric acid (H₂SO₄ is 100 ppm by weight based on the fluorine-containing copolymer) were added to the solution (S3) of the fluorine-containing copolymer obtained in Synthesis Example 3, mixed at 90° C. for 60 minutes and adjusted to 50° C., and 4.9 g of a 10% aqueous NaOH solution as a base and 90 g of ion-exchanged water were added. This aqueous dispersion had a residual vinyl pyrrolidone content of 5 ppm by weight based on the fluorine-containing copolymer.

### Comparative Preparation Example 1

The same procedure as in Preparative Example 1 was repeated to give an aqueous colorless transparent dispersion (RD1) having a solid content of 20%, except that 20.0 g of water and 0.005 g of 10% hydrochloric acid (HCl is 20 ppm by weight based on the fluorine-containing copolymer) were added to the solution (S1) of the fluorine-containing copolymer obtained in Synthesis Example 1, mixed at 90° C. for 120 minutes and adjusted to 70° C. This aqueous dispersion had a residual vinyl pyrrolidone content of 28 ppm by weight based on the fluorine-containing copolymer.

### Comparative Preparation Example 2

The same procedure as in Preparative Example 2 was repeated to give an aqueous colorless transparent dispersion (RD2) having a solid content of 20%, except that 24.9 g of water and 0.225 g of 10% hydrochloric acid (HCl is 900 ppm by weight based on the fluorine-containing copolymer) were added to the solution (S2) of the fluorine-containing copolymer obtained in Synthesis Example 2, mixed at 70° C. for 240 minutes. This aqueous dispersion had a residual vinyl pyrrolidone content of 20 ppm by weight based on the fluorine-containing copolymer.

### Example 1

### Evaluation in the Internal Application Process

An aqueous dispersion (875 g) containing a 0.5 wt % mixture of 40 parts of a beaten LBKP (Leaf Bleached Kraft Pulp) and 60 parts of a beaten NBKP (Needle Bleached Kraft Pulp) having a freeness of 450 ml (Canadian Standard Freeness) was introduced with stirring into the flask, then, 3.1 g of an aqueous solution containing 1 wt % of the cationic starch (SB GUM-POSIT300 produced by SANGUAN WONGSE IND. CO., LTD) was added and the stirring was continued for 1 minute, then 1.3 g of an aqueous solution containing 1 wt % of polyamidoamine-epichlorohydrin (WS-4020 produced by Japan PMC Co., Ltd., a paper strengthening agent in wet condition) was added and the stirring was continued for 1 minute, then 1.3 g of the diluted aqueous dispersion (SD1) containing 1 wt % of the fluorine-containing copolymer was added and the stirring was continued for 1 minute.

The resultant pulp slurry was made into paper with a standard hand papermaking machine described in JIS P8222 (The hand papermaking machine was modified to give a paper having a size of 25 cm×25 cm).

The resultant wet paper was pressed between filter paper sheets under a pressure of 3.5 kg/cm² so as to sufficiently absorb water contained in the wet paper. The wet paper was dried over a drum drier (115° C.×70 seconds) to obtain a water- and oil-resistant paper.

The basis weight of the resultant paper was 70 g/m². The water resistance (Cobb value) of this hand sheet paper was 100 g/m² or more, and the oil resistance (Kit value) was 0, and the oil resistance (AGR value) was 100% and the oil resistance (RP-2 value) was 100%.

### Examples 2 and 3

### Evaluation in the Internal Application Process

The same procedures as in Example 1 were repeated except that each of the aqueous dispersions (SD2 and SD3) of the fluorine-containing copolymer obtained in Preparation Examples 2 and 3 was used instead of the aqueous dispersion (SD1) of the fluorine-containing copolymer in the Example 1. The water resistance and the oil resistance of the obtained water- and oil-resistant papers were evaluated, and the results are shown in Table 2.

### Comparative Examples 1 and 2

### Evaluation in the Internal Application Process

The same procedures as in Example 1 were repeated except that each of the aqueous dispersions (RD1 and RD2) of the fluorine-containing copolymer obtained in Comparative Preparation Examples 1 and 2 was used instead of the aqueous dispersion (SD1) of the fluorine-containing copolymer in Example 1. The water resistance and the oil resistance of the obtained water- and oil-resistant papers were evaluated, and the results are shown in Table 2.

TABLE 2
(Evaluation results in the internal application process)

| | | | | | Com. | Com. |
|---|---|---|---|---|---|---|
| | | Ex. 1 | Ex. 2 | Ex. 3 | Ex. 1 | Ex. 2 |
| Fluorine-containing copolymer | | S1 | S2 | S3 | S1 | S2 |
| solution No | | | | | | |
| Aqueous | Fluorine- | 50 | 50 | 50 | 50 | 50 |
| dispersion | containing | | | | | |
| ingredients | copolymer | | | | | |
| | solution | | | | | |
| | Water | 12.4 | 24.9 | 37.4 | 20.0 | 24.9 |
| | 10% Hydrochloric | 0.125 | 0.225 | — | 0.005 | 0.225 |
| | acid | | | | | |
| | 10% Sulfuric acid | — | — | 0.025 | — | — |
| | 10% NaOH | 4.9 | 4.9 | 4.9 | 4.9 | 4.9 |
| | Water | 90 | 90 | 90 | 90 | 90 |

| | | | | | | |
|---|---|---|---|---|---|---|
| After addition of | Temperature | 85 | 90 | 90 | 90 | 70 |
| hydrochloric acid | (° C.) | | | | | |
| | Time (min.) | 240 | 120 | 60 | 120 | 240 |
| Oil resistance | AGR (%) | 0 | 0 | 0 | 0 | 0 |
| | RP-2 (%) | 0 | 0 | 0 | 0 | 0 |
| | Kit | 7 | 8 | 7 | 7 | 7 |
| Water resistance | Cobb (g/m²) | 23 | 24 | 25 | 25 | 24 |

| | | | | | |
|---|---|---|---|---|---|
| Stability of aqueous dispersion | Good | Good | Good | Good | Good |
| Residual amount of vinyl | 3 | 1 | 5 | 28 | 20 |
| pyrrolidone (ppm) | | | | | |

From the results of Table 2, it is understood that Examples 1 to 3 have the decreased content of vinyl pyrrolidone of at most 10 ppm, and excellent oil resistance and water resistance, while Comparative Examples 1 and 2 do not have the decreased content of vinyl pyrrolidone of at most 10 ppm.

### Example 4

### Evaluation in the Surface Application Process

### “Preparation of a Paper to be Tested”

A paper to be tested was produced by using a paper manufacturing machine. The production process is shown below.

The types of pulp used were LBKP (Leaf Bleached Kraft Pulp) and NBKP (Needle Bleached Kraft Pulp), and their ratio was 6/4 (L/N) and the freeness of the pulp was 400 ml (Canadian Standard Freeness). Into a slurry of the pulp having a concentration of about 2%, a cationized starch Stayloc 400 (produced by Tate & Lyle) was added in 2 wt % based on the dried pulp weight, and further a size agent Hercon 70 (produced by Hercules Corp.) was added in 0.0375 wt % based on the dried pulp weight. A paper was produced from the pulp slurry by using a Fourdrinier machine. The basis weight of the paper obtained was 60 g/m² and the thickness was 0.01 mm. The water resistance (Cobb value) was 80, and the oil resistance (Kit value) was 0.

The water- and oil-resistant paper (treated paper) was produced in the procedure described below using, as a water- and oil-resistant agent, the aqueous dispersion solution (SD1) of the fluorine-containing copolymer obtained in Preparation Example 1.

An aqueous starch solution was prepared by dissolving ethylated starch Penford Gum 290 (produced by Penford Products Co.) in a hot water of 80° C. or more for 30 minutes. The aqueous dispersion solution (SD1) of the fluorine-containing copolymer obtained in Preparation Example 1 was diluted so that the solid content of the aqueous starch solution was 1.5 wt % and the solid content of the aqueous dispersion (SD1) of the fluorine-containing copolymer was 0.2 wt %, to give a water- and oil-resistant composition.

The paper prepared above was dipped in the water- and oil-resistant composition for 5 seconds and dried at 115° C. for 70 seconds to obtain a raw paper for test.

The evaluation results of the water resistance and the oil resistance obtained are shown in Table 3.

### Examples 5 and 6

### Evaluation in the Surface Application Process

Using, as the water- and oil-resistant agent, each of the aqueous dispersion solutions (SD2 and SD3) of the fluorine-containing copolymer obtained in Preparation Examples 2 and 3, the water- and oil-resistant compositions were obtained by diluting the aqueous dispersion solutions (SD2 and SD3) to adjust the solid content to 0.2 wt %. Using each composition, the water resistance and the oil resistance were evaluated in the same way as in Example 4. The obtained results are shown in Table 3.

### Comparative Examples 5 and 6

### Evaluation in the Surface Application Process

Using, as the water- and oil-resistant agent, each of the aqueous dispersion solutions (RD1 and RD2) of the fluorine-containing copolymer obtained in Comparative Preparation Examples 1 and 2, the water- and oil-resistant compositions were obtained by diluting the aqueous dispersion solutions (RD1 and RD2) to adjust the solid content to 0.2%. Using each composition, the water resistance and the oil resistance were evaluated in the same way as Example 4. The obtained results are shown in Table 3.

TABLE 3
(Evaluation results in the surface application process)

| | | | | | Com. | Com. |
|---|---|---|---|---|---|---|
| | | Ex. 4 | Ex. 5 | Ex. 6 | Ex. 5 | Ex. 6 |
| Fluorine-containing copolymer | | S1 | S2 | S3 | S1 | S2 |
| solution No. | | | | | | |
| Aqueous | Fluorine- | 50 | 50 | 50 | 50 | 50 |
| dispersion | containing | | | | | |
| ingredients | copolymer | | | | | |
| | solution | | | | | |
| | Water | 12.4 | 24.9 | 37.4 | 20.0 | 24.9 |
| | 10% Hydrochloric | 0.125 | 0.225 | — | 0.005 | 0.225 |
| | acid | | | | | |
| | 10% Sulfuric acid | — | — | 0.025 | — | — |
| | 10% NaOH | 4.9 | 4.9 | 4.9 | 4.9 | 4.9 |
| | Water | 90 | 90 | 90 | 90 | 90 |

| | | | | | | |
|---|---|---|---|---|---|---|
| After addition of | Temperature | 85 | 90 | 90 | 90 | 70 |
| Hydrochloric acid | (° C.) | | | | | |
| | Time (min.) | 240 | 120 | 60 | 120 | 240 |
| Oil resistance | AGR (%) | 0 | 0 | 0 | 0 | 0 |
| | RP-2 (%) | 0 | 0 | 0 | 0 | 0 |
| | Kit | 8 | 8 | 8 | 7 | 7 |
| Water resistance | Cobb (g/m²) | 20 | 19 | 20 | 20 | 19 |

| | | | | | |
|---|---|---|---|---|---|
| Stability of aqueous dispersion | Good | Good | Good | Good | Good |
| Residual amount of vinyl | 3 | 1 | 5 | 28 | 20 |
| pyrrolidone (ppm) | | | | | |

From the results of Table 2, it is understood that Examples 4 to 6 have the decreased content of vinyl pyrrolidone of at most 10 ppm, and excellent oil resistance and water resistance, while Comparative Examples 5 and 6 do not have the decreased content of vinyl pyrrolidone of at most 10 ppm.

### INDUSTRIAL APPLICABILITY

The present invention provides water- and oil-resistant agent which has the decreased content of vinyl pyrrolidone monomer and which comprises the environmentally-benign fluorine-containing copolymer having a C₁-C₆ fluoroalkyl group, and which can impart the superior water- and oil-resistance to substrates such as paper, woven fabric and non-woven fabric, particularly paper. The present invention can be utilized for fields of a water- and oil-resistant treatment paper.

1. A water- and oil-resistant agent comprising a fluorine-containing copolymer comprising the repeating units derived from:
(a) a fluorine-containing monomer having a fluoroalkyl group represented by the general formula:
CH₂═C(—X)—C(═O)—Y—Z—Rf (1)
wherein X represents a hydrogen atom, a linear or branched C₁ to C₂₁ alkyl group, a fluorine atom, a chlorine atom, a bromine atom, an iodine atom, a CFX¹X² group wherein X¹ and X² are a hydrogen atom, a fluorine atom, a chlorine atom, a bromine atom or an iodine atom, a cyano group, a linear or branched C₁ to C₂₁ fluoroalkyl group, a substituted or non-substituted benzyl group, or a substituted or non-substituted phenyl group;
Y is —O— or —NH—;
Z is a C₁ to C₁₀ aliphatic group, a C₆ to C₁₀ aromatic or cyclic aliphatic group,
a —CH₂CH₂N(R¹)SO₂— group wherein R¹ is a C₁ to C₄ alkyl group,
a —CH₂CH(OZ¹)CH₂— group wherein Z¹ is a hydrogen atom or an acetyl group,
a —(CH₂)ₘ—SO₂—(CH₂)ₙ— group or a —(CH₂)ₘ—S—(CH₂)ₙ— group wherein m is from 1 to 10 and n is from 0 to 10, and
Rf is a linear or branched C₁ to C₆ fluoroalkyl group,
(b) a vinylpyrrolidone monomer represented by the general formula: 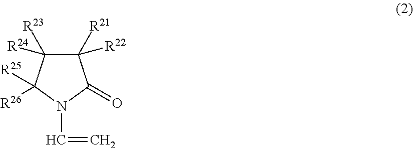
wherein R²¹, R²², R²³, R²⁴, R²⁵ and R²⁶ are the same or different, and represent a hydrogen atom or a C₁ to C₄ alkyl group;
(c) a monomer having an anion-donating group, and
(d) a fluorine free (meth)acrylate monomer,
wherein a residual amount of the vinylpyrrolidone monomer (b) is at most 10 ppm by weight based on the fluorine-containing polymer.

2. The water- and oil-resistant agent claimed in claim 1, wherein the fluoroalkyl group (Rf group) in the monomer (a) is a perfluoroalkyl group.

3. The water- and oil-resistant agent claimed in claim 1, wherein the fluoroalkyl group (Rf group) in the monomer (a) is a C₄ to C₆ perfluoroalkyl group.

4. The water- and oil-resistant agent claimed in claim 1, wherein the monomer (b) is at least one selected from the group consisting of N-vinyl-2-pyrrolidone, N-vinyl-3-methyl-2-pyrrolidone, N-vinyl-4-methyl-2-pyrrolidone, N-vinyl-5-methyl-2-pyrrolidone and N-vinyl-3,3-dimethyl-2-pyrrolidone.

5. The water- and oil-resistant agent claimed in claim 1, wherein the monomer (c) is a compound having an anion-donating group and a carbon-carbon double bond.

6. The water- and oil-resistant agent claimed in claim 1, wherein the anion-donating group is a carboxylic acid group or a sulfonic acid group.

7. The water- and oil-resistant agent claimed in claim 1, wherein the monomer (c) is at least one selected from the group consisting of (meth)acrylic acid, crotonic acid, maleic acid, fumaric acid, itaconic acid, citraconic acid, vinylsulfonic acid, (meth)allylsulfonic acid, styrene sulfonic acid, vinylbenzene sulfonic acid, acrylamide-tert-butylsulfonic acid, and salts thereof.

8. The water- and oil-resistant agent claimed in claim 1, wherein the fluorine-free (meth)acrylate monomer (d) is at least one fluorine-free (meth)acrylate monomer selected from the group consisting of alkyl(meth)acrylate, oxyalkylene(meth)acrylate, oxyalkylene di(meth)acrylate and (meth)acrylate ester.

9. The water- and oil-resistant agent claimed in claim 1, wherein the fluorine-free (meth)acrylate monomer (d) is at least one oxyalkylene(meth)acrylate or oxyalkylene di(meth)acrylate represented by the general formulas:
CH₂═CX¹C(═O)—O—(RO)ₙ—X² (3a)
and
CH₂═CX¹C(═O)—O—(RO)ₙ—C(═O)CX¹═CH₂ (3b)
wherein X¹ is a hydrogen atom or a methyl group,
X² is a hydrogen atom or a saturated or unsaturated C₁ to C₂₂ hydrocarbon group,
R is a C₂ to C₆ alkylene group, and
n is an integer from 1 to 90.

10. The water- and oil-resistant agent claimed in claim 1, wherein the fluorine-free (meth)acrylate monomer (d) is one or a mixture of 2-hydroxyethyl(meth)acrylate and ω-hydroxy-polyoxyethylene acrylate wherein an average polymerization degree (n) of the polyoxyethylene group is 3 to 10.

11. The water- and oil-resistant agent claimed in claim 1, wherein the weight ratio of the monomers (a):(b):(c):(d) in the fluorine-containing copolymer is 40-90:1-30:1-30:1-40.

12. The water- and oil-resistant agent claimed in claim 1, wherein the monomer (a) is at least one fluorine-containing monomer wherein Rf in the general formula (1) represents a C₄ to C₆ perfluoroalkyl group,
the monomer (b) is at least one selected from the group consisting of N-vinyl-2-pyrrolidone, N-vinyl-3-methyl-2-pyrrolidone, N-vinyl-4-methyl-2-pyrrolidone, N-vinyl-5-methyl-2-pyrrolidone and N-vinyl-3,3-dimethyl-2-pyrrolidone,
the monomer (c) is at least one selected from the group consisting of (meth)acrylic acid, crotonic acid, maleic acid, fumaric acid, itaconic acid and citraconic acid, and
the monomer (d) is at least one selected from the group consisting of 2-hydroxyethyl methacrylate, ω-hydroxy-polyoxyethylene acrylate wherein an average polymerization degree (n) of the polyoxyethylene group is 3 to 10, 2-hydroxypropyl(meth)acrylate, 4-hydroxybutyl(meth)acrylate, methyl(meth)acrylate, n-butyl(meth)acrylate and t-butyl(meth)acrylate.

13. The water- and oil-resistant agent claimed in claim 1, wherein
the monomer (a) is F(CF₂)₄CH₂CH₂OCOCH═CH₂, F(CF₂)₆CH₂CH₂OCOCH═CH₂ or a mixture thereof,
the monomer (b) is N-vinyl-2-pyrrolidone,
the monomer (c) is methacrylic acid or acrylic acid, and
the monomer (d) is at least one of 2-hydroxyethyl(meth)acrylate and ω-hydroxy-polyoxyethylene acrylate wherein an average polymerization degree (n) of the polyoxyethylene group is 3 to 10.

14. A method for preparing the water- and oil-resistant agent according to claim 1, comprising a step of adding an acid to a dispersion or solution of the fluorine-containing copolymer, and heating the dispersion or solution to decrease a residual amount of the vinyl pyrrolidone monomer (b) to at most 10 ppm by weight based on the fluorine-containing copolymer.

15. The method claimed in claim 14, which comprises adding at least one acid selected from the group consisting of phosphoric acid, hydrochloric acid, nitric acid and sulfuric acid.

16. The method claimed in claim 14, which comprises the steps of:
(1) polymerizing a monomer in the presence of a liquid medium, to give a dispersion or solution of a fluorine-containing copolymer,
(2) adding an acid to the dispersion or solution of a fluorine-containing copolymer, and heating the dispersion or solution to decrease the residual amount of the vinyl pyrrolidone monomer (b) to 10 ppm by weight or less based on the fluorine-containing copolymer, and
(3) neutralizing an anionic donating group of the fluorine-containing copolymer.

17. The method claimed in claim 14, which comprises, in the decrease step, a mixture of the fluorine-containing copolymer, the liquid medium and the acid is heated to a temperature of at least 80° C.

18. The method claimed in claim 14, wherein the amount of the acid added for decreasing the residual amount of the monomer (b) is 30 to 1500 ppm by weight, based on the fluorine-containing copolymer.

19. The method claimed in claim 14, wherein the weight ratio of the fluorine-containing copolymer to the liquid medium is 15-70:30-85.

20. The method claimed in claim 14, wherein the liquid medium is a combination of water and at least one organic solvent selected from acetone, methyl ethyl ketone, methanol, ethanol and isopropanol, and the mixing weight ratio of water to the organic solvent is 20-70:30-80.

21. A method for treating paper to be water- and oil-resistant, wherein the method comprises a step of applying the water and oil resistant agent claimed in claim 1 to the whole paper including internal parts of paper.

22. The method claimed in claim 21, wherein the step of applying the water and oil resistant agent to the whole paper is a step of applying the water and oil resistant agent to a pulp at a papermaking stage.

23. The method claimed in claim 22, wherein the water and oil resistant agent is used in an amount that a weight ratio of the fluorine atoms is 0.01 to 1.0% by weight based on the weight of the pulp.

24. A method for treating paper to be water and oil-resistant, wherein the method comprises a step of applying the water and oil resistant agent claimed in claim 1 to a surface of the paper.

25. The method claimed in claim 24, wherein the water and oil resistant agent is used in an amount that a weight ratio of the fluorine atoms is 0.005 to 0.6% by weight based on the weight of the paper.

26. A paper treated with the water and oil resistant agent claimed in claim 1.

27. An internally treated paper obtained by the method claimed claim 21.

28. An externally treated paper obtained by the method claimed claim 24.

29. A composition for paper treatment, comprising the water- and oil-resistant agent claimed in claim 1 and an additive.

30. The water- and oil-resistant agent claimed in claim 1, which further comprises a liquid medium in addition to the fluorine-containing copolymer.
